(19) United States
(12) Patent Application Publication
(10) Pub. No.: US 2009/0128579 A1
(43) Pub. Date: May 21, 2009

(54) Method of producing test-wearing face image for optical products

(76) Inventor: Yiling Xie, Arcadia, CA (US)

Correspondence Address: DAVID AND RAYMOND PATENT FIRM, 108 N. YNEZ AVE., SUITE 128, MONTEREY PARK, CA, 91754, US

(21) Appl. No.: 11/986,527

(22) Filed: Nov. 20, 2007

(51) Int. Cl. G09G 5/00

(52) U.S. Cl. 345/634

(57) ABSTRACT

A method of producing test-wearing face image for optical products includes the steps of posting a facial image of a user on a posting platform; selecting at least one of spectacle frame images from a frame database; matching the spectacle frame image with respect to the facial image; generating a temple effect for each of the temples of the spectacle frame image to form a visible portion extended from the outer side of the respective lens to a facial side peripheral of the facial image and an invisible portion extended from the visible portion at a position out of the facial side peripheral of the facial image; and generating a virtual appearance of the user test-wearing a spectacle frame in responsive to the spectacle frame image thereof, such that the spectacle frame image matches with a facial size of the facial image of the user.

### BACKGROUND OF THE PRESENT INVENTION

1. Field of Invention

The present invention relates to optical products, and more particularly to a system and method of producing test-wearing face image for optical products, wherein the optical product optimization system comprises a temple effect module which modifies the temple of each of the spectacle frame images so as to enhance the match of the spectacle frame image on the facial image.

2. Description of Related Arts

Every eyeglasses wearer would like to test wear all favor spectacles of different styles so as to ensure which style fits his or her face the most before he or she purchases a new pair of spectacles. Although there are thousands of new spectacle designs in market, each spectacle shops may only provide a very limited number of selected spectacles in stock. The user may miss the chance of trying some other spectacle designs before making decision. On the other hands, a spectacle shop may lose a potential customer simply because it fails to carry a particular pair of spectacles that the customer likes.

Due to the rapid development of the Internet, nearly every family in the United States has at least a computer that enables people to shopping through Internet. Numerous spectacle webs are available in Internet, each of which provides pictures of all kinds of spectacles for the consumers to purchase. However, most of the eyeglasses wearers would like to test-wear the selected pair of spectacles to ensure it fits his or her face before purchasing.

U.S. Pat. No. 5,983,201, owned by Fay, discloses a method for a customer to test-wear the eyeglass frame through a personal computer that how the customer would appear wearing different eyeglass frame fitted, electronically to the customer. Accordingly, the method requires the customer to physically visit a Customer Diagnostics Location for sizing and imaging the customer in order to confirm the customer's head, face and skin color, sex etc. needed to size the eyeglasses. Therefore, the customer is able to access a Remote Electronic Store to try on frames and inspect frame product on the image of the customer. It is no doubt that the customer is able to test wear all the frames before placing a purchasing order on the selected frame. However, the method has several drawbacks.

The image of the customer must be restrictedly examined by the Customer Diagnostics Location to ascertain the image of the customer that the image thereof is qualified to be used in the Remote Electronic Store for matching the frames. In other words, the customer is appointed to obtain the image thereof at the Customer Diagnostics Location even the customer cannot find any frame matching the image at the Customer Diagnostics Location. Furthermore, the location of the Customer Diagnostics Location may not close to the house or office of the customer such that the customer must look for the closest location of the Customer Diagnostics Location. As a result, the customer may merely waste lots of time and/or money to visit the Customer Diagnostics Location and the Customer Diagnostics Location in comparison with the conventional method of visiting the retail optical shop.

In addition, when the face of the customer has changed due to the age or weight, the customer may merely visit the Customer Diagnostics Location again to obtain an updated image. In other words, the customer may visit the Customer Diagnostics Location once a year because the optometrist suggests everyone should have an eye examination for every year.

In relation to shopping of optical products, the main hassle is that the customer must visit the optometry to get the prescription, select the desirable spectacle frame, and then place the corresponding order. After an agreed period of time, the customer has to revisit the retail shop again to pick up the spectacle. Many peoples do not want this to be so but they have no choice because seemingly this is the only way of buying a spectacle.

Furthermore, the frame image of the Remote Electronic Store does not match with the facial image of the customer because the end portions of the temples of the frame image are overlapped on the outer sides of the facial image of the customer respectively. It is known that when the customer wears the spectacle frame, the end portions of the temples are hidden behind the auricles of the customer's ears respectively. Otherwise, the end portions of the temples are covered by the hairs of the customer especially for the lady having a long hair. In fact, when the customer physically wears the spectacle frame, the pupil marks of the customer may not perfectly match with two focus points of the spectacles. Generally speaking, the focus points of the spectacles are slightly offset to the pupil marks of the customer due to the weight of the spectacles and the movement of the customer. In other words, no matter how the spectacle image being adjusted its size in responsive to the size of the facial image of the customer, the spectacle image cannot be matched with the facial image of the customer naturally.

### SUMMARY OF THE PRESENT INVENTION

A main object of the present invention is to provide a system and method of producing test-wearing face image for optical products, wherein the optical product optimization system comprises a temple effect module which modifies the temple of each of the spectacle frame images so as to enhance the match of the spectacle frame image on the facial image.

Another object of the present invention is to provide a system and method of producing test-wearing face image for optical products, wherein the spectacle frame image produces an optimal simulation of the spectacle frame on the facial image so as to make the pupil marks with two focus points matching with the spectacle frame naturally.

Another object of the present invention is to provide a system and method of producing test-wearing face image for optical products, wherein the user is able to shop the optical products through a public communication network, such that the user is able to customize the optical products through the public communication network to selectively match the facial image with the optical products without physically wearing on the optical products.

Another object of the present invention is to provide a system and method of producing test-wearing face image for optical products, wherein a user is able to optimize the optical products through the public communication network to selectively match his/her face image with the optical products in a rapid and accurate manner.

Another object of the present invention is to provide a system and method of producing test-wearing face image for optical products, wherein the user is able to provide his or her full frontal photo as the facial image in his or her personal computer to match with the optical products pre-stored in the system. Therefore, the user does not have to visit any optical office or store to obtain the facial image so as to speed up the process of purchasing the optical products through the public communication network.

Another object of the present invention is to provide a system and method of producing test-wearing face image for optical products, wherein the calibrating step of the facial image is as simple as locating two pupil marks on two pupils of the facial image, the frame scale of the optical product is automatically matched with the facial image with respect to the pupil marks.

Another object of the present invention is to provide a system and method of producing test-wearing face image for optical products, wherein the final test-wear image is generated to slightly offset the focus points of the spectacle frame with the facial image of the user to simulate the actual wearing image for the user.

Another object of the present invention is to provide a system and method of producing test-wearing face image for optical products, wherein the user is able to update the facial image anytime by using a digital camera, a web cam or even scanning a photo, such that the user is able to shop the optical products anytime by a click of a mouse.

Another object of the present invention is to provide a system and method of producing test-wearing face image for optical products, wherein when the user provides a color facial image, the color of the optical product can be selected to match with the skin color of the user once the shape of the spectacle frame is selected. Therefore, the preview is shown as a mirror image to show how the user would appear while wearing the spectacle frame with the selected shape and color.

Another object of the present invention is to provide a system and method of producing test-wearing face image for optical products, wherein the system can calibrate the facial image in different angles, such as a three quarter face position, to match the frame scale of the optical product with the facial image so as to provide alternative view of the appearance.

Another object of the present invention is to provide a system and method of producing test-wearing face image for optical products, wherein no expensive or complicated structure is required to employ in the present invention in order to achieve the above mentioned objects. Therefore, the present invention successfully provides an economic and efficient solution for providing a method and system for the user to test-wear the optical products through the public communication network.

Accordingly, in order to accomplish the above objects, the present invention provides a method of producing test-wearing face image for optical products, comprising the steps of:

(a) posting a facial image of a user on a posting platform;

(b) selecting at least one of spectacle frame images from a frame database, wherein each of the spectacle frame images contains images of two lens, two temples outwardly extended from two outer sides of the lens respectively, and a spectacle bridge extended between two inner sides of the lens respectively;

(c) matching the spectacle frame image with respect to the facial image; and

(d) generating a temple effect for each of the temples of the spectacle frame image to form a visible portion extended from the outer side of the respective lens to a facial side peripheral of the facial image and an invisible portion extended from the visible portion at a position out of the facial side peripheral of the facial image; and

(e) generating a virtual appearance of the user test-wearing a spectacle frame in responsive to the spectacle frame image thereof, such that the spectacle frame image matches with a facial size of the facial image of the user.

The present invention further provides a method of shopping optical products through a public communication network, comprising the steps of:

(a) providing a remote shopping center for a customer to access through the public communication network, wherein the remote shopping center provides a posting platform allowing the customer to post a facial image thereof through the public communication network;

(b) selecting at least one of spectacle frame images from a frame database to fittingly overlap the spectacle frame image on the facial image, wherein each of the spectacle frame images contains a frame scale with respect to a real size of the respective spectacle frame;

(c) simulating a virtual appearance of the customer test-wearing the respective spectacle frame; and

(d) receiving an order of the respective spectacle frame selected by the customer.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of a system for optimizing optical products through a public communication network according to a preferred embodiment of the present invention.

FIG. 2 is a first schematic diagram of the measurement of the pupil marks of the facial image according to the above preferred embodiment of the present invention.

FIG. 3 is an alternative mode of the measurement of the pupil marks of the facial image according to the above preferred embodiment of the present invention.

FIG. 4 is a schematic diagram of the facial image according to the above preferred embodiment of the present invention, illustrating that the spectacle frame image is overlapped on the facial image.

FIG. 5 is a method of optimizing optical products through a public communication network according to a preferred embodiment of the present invention.

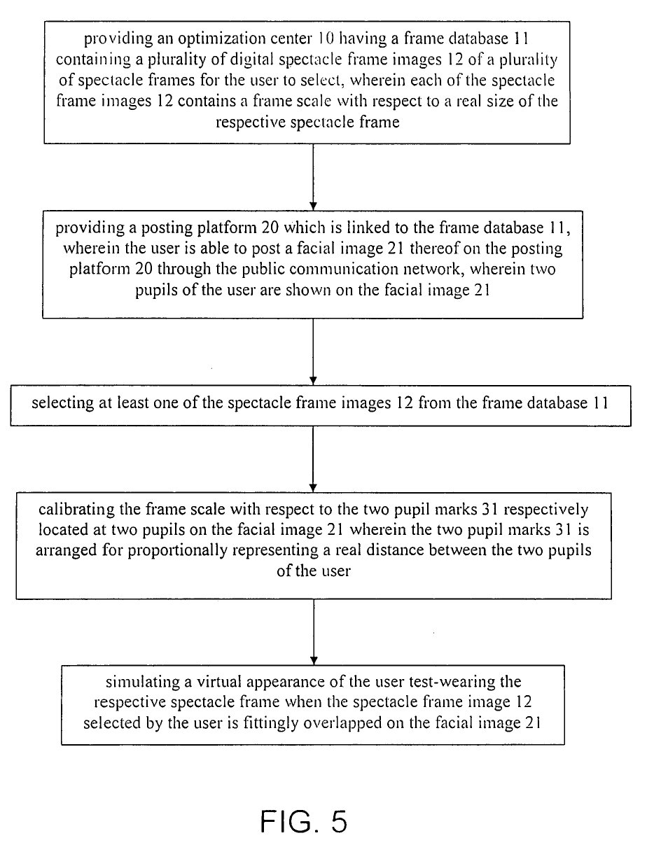

FIG. 6 is a method of shopping optical products through a public communication network according to a preferred embodiment of the present invention.

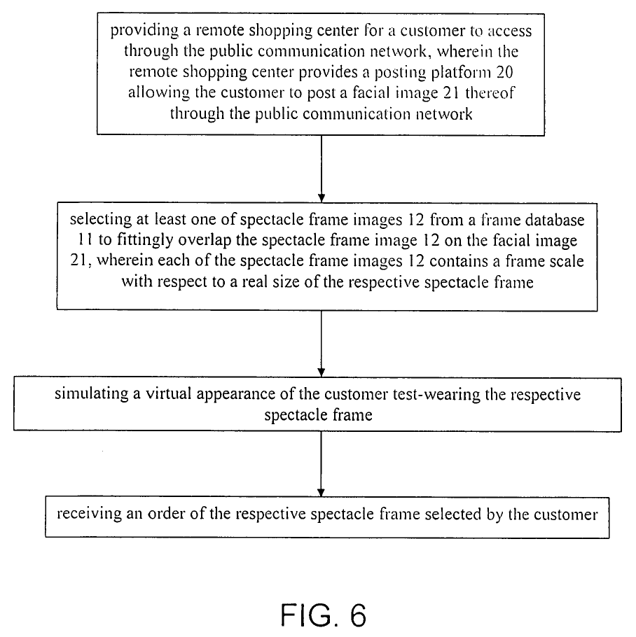

FIG. 7 is a flow diagram illustrating the process for generating the temple effect according to the above preferred embodiment of the present invention.

FIG. 8 illustrates the spectacle frame image overlapped on the facial image to crop the temple hidden area according to the above preferred embodiment of the present invention.

FIG. 9 illustrates the re-production image overlapping on the facial image at an exact location after the spectacle frame image is placed on the facial image according to the above preferred embodiment of the present invention.

FIG. 10 illustrates the spectacle frame image overlapped on the facial image to make the temple vanishing mark along the temple of the spectacle frame image according to the above preferred embodiment of the present invention.

FIG. 11 illustrates the temple being vanished from the temple vanishing mark to an end of the temple according to the above preferred embodiment of the present invention.

### DETAILED DESCRIPTION OF THE PREFERRED EMBODIMENT

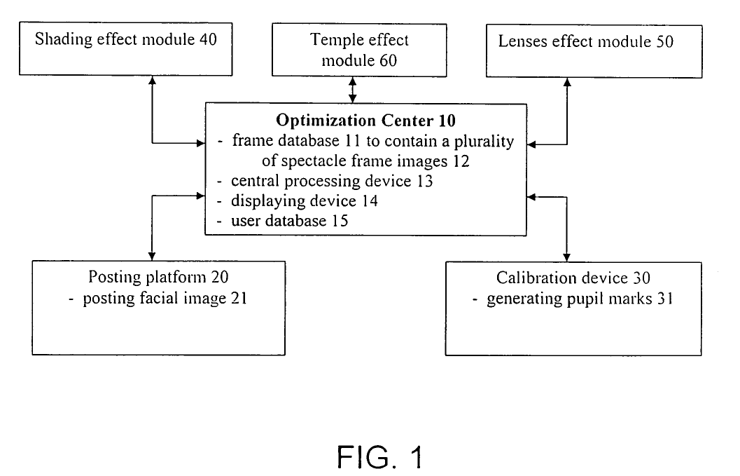

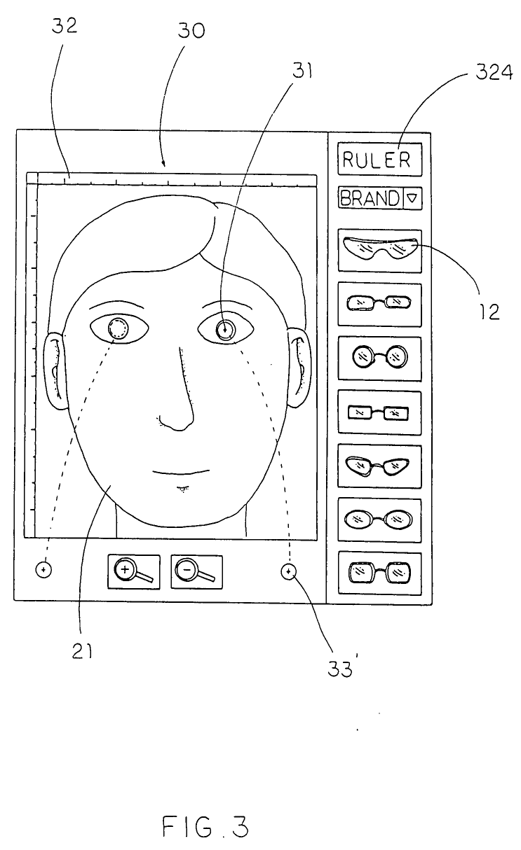

Referring to FIG. 1 to FIG. 4 of the drawings, a system of optimization optical products, such as glasses, through a public communication network according to a preferred embodiment of the present invention is illustrated, wherein the optical products optimization system comprises an optimization center 10, a posting platform 20, and a calibration device 30. According to the preferred embodiment, the system is used in an optical products business for facilitating convenient and simple mode of business method while the customer's satisfaction is optimized.

The optimization center 10 has a frame database 11, which is adapted for a user to access through the public communication network, such as Internet, containing a plurality of digital spectacle frame images 12 of a plurality of spectacle frames for the user to select, wherein each of the spectacle frame images 12 contains a frame scale with respect to a real size of the respective spectacle frame.

The posting platform 20, which is communicatively linked to the frame database 11, is adapted for the user posting a facial image 21 thereof on the posting platform 20 through the public communication network, wherein two pupils of the user are shown on the facial image 21.

The calibration device 30 calibrates the frame scale with two reference marks located at two reference images of the user on the facial image 21 respectively to fittingly overlap the spectacle frame image 12 selected by the user on the facial image 21 for simulating a virtual appearance of the user wearing the respective spectacle frame, wherein the two reference marks are arranged for proportionally representing a real distance between the two reference images of the user. Accordingly, the two reference marks according to the preferred embodiment are two pupil marks 31 and the two reference images are two pupils of the user on the facial image 21. In other words, the two pupil marks 31 proportionally represent a real distance between the two pupils of the user to calibrate the frame scale with respect to the user.

The above mentioned spectacle frame, such as a conventional spectacle frame, generally comprises a frame body for mounting a pair of lenses in position, wherein the frame body comprises a bridge connected between the two lenses and two temples provided at two outer sides of the lenses for coupling a pair of temples respectively. The frame body of the spectacle frame can be constructed as the conventional spectacle frame to have a pair of lens rims or the rimless frame that the bridge is directly fastened between two inner sides of the two lenses.

According to the preferred embodiment of the present invention, the digital spectacle frame images 12 are pre-loaded into the frame database 11 of the optimization center 10 for simulating the virtual appearance of the user wearing the respective spectacle frame. Moreover, the optimization center 10 further comprises a displaying device 14 and a central processing device 13 electrically connected with the displaying device 14, the frame database 11, the posting platform 20, and the calibration device 30 for coordinating image matching of the facial images 21 and the spectacle frame images 12. The system of the present invention further comprises means for generating the virtual appearance after the simulation thereof is formed. Accordingly, the generating means can be a program or other devices to finalize the virtual appearance on the posting platform 20.

The posting platform 20 further comprises an image capturing device 22 electrically connected with the optimization center 10 to capture a physical image of the user's face as the facial image 21 in digital form so as to facilitate further matching with the spectacle frame images 12 stored in the frame database 11.

The image capturing device 22 is preferably embodied as a pre-determined digital camera which is adapted to capture physical image into a digital format which may then be processed by the optimization center 10 so as to display it through the displaying device 14. It is worth mentioning that the image capturing device 22 can also be embodied as other conventional image capturing devices such as a conventional camera, in which case the image captured may need to be digitalized by, for example, a scanner so as to form the facial image 21.

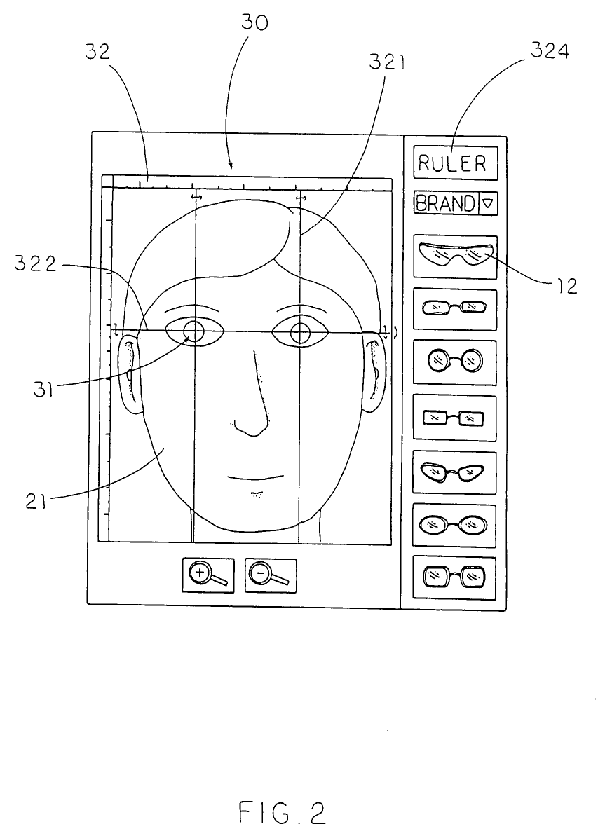

Referring to FIG. 2 of the drawings, the calibration device 30 comprises a measuring ruler 32 represented in digital form for measuring a distance between the two pupil marks 31 on the facial image 21 as captured by the posting platform 20. The measuring ruler 32 is embodied as containing a longitudinal measuring line 321 movably provided on the posting platform 20 for longitudinally aligning with the two pupils of the user on the facial image 21, and two transverse measuring lines 322 movably provided on the posting platform 20 for transversely aligning with the two pupils of the user on the facial image 21 respectively, wherein the two pupil marks are formed at two intersections of the longitudinal measuring line 321 and the transverse measuring lines 322.

In other words, the longitudinal measuring line 321 and the transverse measuring lines 322 are arranged to cross with each other for determining a coordinate of one pupil as shown on the facial image 21, wherein the longitudinal measuring line 321 and the transverse measuring line 322 are adapted to move vertically and horizontally over the facial image 21 to locate the coordinate of the another pupil. The two sets of coordinates are then calculated to obtain a distance between the two pupils which are designated by the two pupil marks 31.

Accordingly, the calibration device 30 further contains a measuring scale 323 longitudinally formed on the posting platform 20 to measure a distance between the two transverse measuring lines 321, 322 for proportionally determining the real distance between the two pupils of the user.

As an obvious alternative, the calibration device may instead comprise a printable measuring ruler 324 provided on the optimization center 10 for the user printing out the measuring ruler 324 to measure the real distance between the two pupils of the user so as to selectively adjust the two transverse measuring lines 321, 322 to line up with the pupils on the facial image 21 respectively.

After the distance between the two pupil marks 31 have been obtained, the relevant spectacle frame images 12 may then be selected to match with the facial image 21 so as to simulate a virtual appearance of the user wearing the respective spectacle frame. Accordingly, the user of the present invention is able to fit a wide variety of spectacle frame images 12 onto the facial image 21 so as to appreciate its overall appearance of the corresponding spectacle when worn on the user's face.

Accordingly, it can be seen that each of the spectacle frame images 12 represents a carefully and accurately scaled image derived from the corresponding spectacle frames and stored in the frame database 11 of the optimization system 10. The capturing of the spectacle frames for forming the spectacle frame images 12 can be accomplished following specifically created guidelines so as to produce spectacle frame images 12 which comply with the necessary scaling and resolution features.

As a result, each of the spectacle frame images 12 may contain the images of the frame body, the two temples, the spectacle bridge, and preferably the lenses. However, it is open for a user of the present invention to select which portion of the spectacle frame images 12 is to be shown. For example, the user may only want to see the frame body, the bridge, the lenses but not the temples. This can be accomplished by the present invention. At this stage, it is important to point out that the central processing device 13 may digitally tilt or trim predetermined portions of predetermined spectacle frame images 12 so that the resulting spectacle frame images 12 can be optimally fitted for specific facial images 21.

As a preferred embodiment, each of the spectacle frame images 12 is a digital image of the respective spectacle frame having a predetermined shape and size wherein the two temples are not shown in the spectacle frame image 12. In other words, only the frame body is captured in the spectacle frame image 12. However, the temple can be optionally added into the spectacle frame image 12 to show the virtual appearance of the user wearing the respective spectacle frame.

Thus, it is worth mentioning that the present invention can be optimally utilized for a spectacle selling business which provides customers with the chance of appreciating a wide variety of spectacles without physically wearing on the large numbers of spectacles. It can be proved to be extremely efficient and effective, as the customers are provided with the frame database 11 which is loaded with extensive range of spectacle frame images 12. Moreover, the user may be able to enter prescription to the optimization center 10 for generating lenses with corresponding radius of curvature.

In order to optimally overlap the spectacle frame image on the facial image 21, the spectacle frame image 12 is fixed and the facial image 21 displayed on the posting platform is adapted to be proportionally zoomed in and out until the two pupil marks 31 are proportionally located at the two pupils on the facial image 21 corresponding to the real distance between the two pupils of the user.

Alternatively, the facial image 21 displayed on the posting platform 20 is fixed and the spectacle frame image 12 is adapted to be proportionally zoomed in and out until the spectacle frame image 12 is proportionally matched with the two pupil marks 31 corresponding to the real distance between the two pupils of the user.

In order to further enhance the features of the present invention, the optical products optimization system further comprises a shading effect module 40 and a lenses effect module 50 electrically connected with the central processing device 13 for producing a shading effect and a lenses reflection effect to the virtual appearance of the user wearing the respective spectacle frame respectively. Thus, the ultimately virtual appearance of the user may be appropriately shaded and the lenses featured so as to create a highly accurate appearance of the spectacle. For example, the lenses may be appropriately featured with predetermined colors or predetermined patterns so that the user may choose his/her most desirable lenses via the present invention. The relevant information of the selected spectacle may then be sent to the glasses retailers or even the manufacturer for manufacturing the corresponding spectacle as optimized by the user in question.

In other words, the lens effect module 50 modifies the lenses of each of the spectacle frame images 12 when the spectacle frame image is overlapped on the facial image 21, wherein the lens effect module 50 generates a reflection effect on each of the lenses for enhancing the virtual appearance of the user test-wearing the respective spectacle frame.

Moreover, the shading effect module 40 modifies each of the spectacle frame images 12 when the spectacle frame image 12 is overlapped on the facial image 21, wherein the shading effect module 40 generates a frame shading on the facial image 21 with respect to the spectacle frame image 12 for enhancing the virtual appearance of the user test-wearing the respective spectacle frame.

The optical product optimization system further comprises a temple effect module 60 which modifies the temple of each of the spectacle frame images 12 when the spectacle frame image 12 is overlapped on the facial image 21 for enhancing the virtual appearance of the user test-wearing the respective spectacle frame, wherein the temple effect module 60 modifies each of the temples to form a visible portion extended from the outer side of the respective lens to a facial side peripheral of the facial image 21 and an invisible portion extended from the visible portion at a position out of the facial side peripheral of the facial image 21.

It is worth mentioning that the user, having a particular facial image 21, may nevertheless select a particular spectacle frame image 12 for simulating the appearance of the wearer.

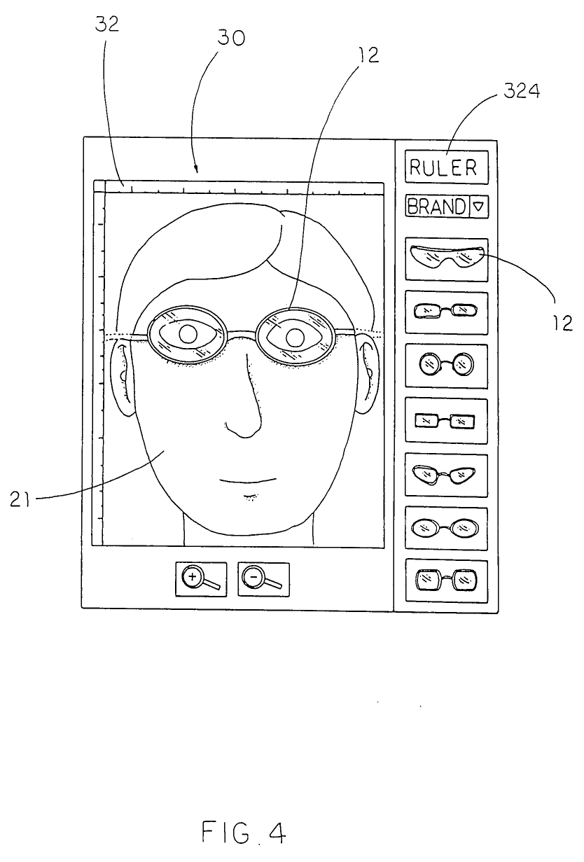

Referring to FIG. 4 of the drawings, a method of optimizing optical products through a public communication network is illustrated, in which the method comprises the steps of:

(a) providing an optimization center 10, which is adapted for a user to access through the public communication network, having a frame database 11 containing a plurality of digital spectacle frame images 12 of a plurality of spectacle frames for the user to select, wherein each of the spectacle frame images 12 contains a frame scale with respect to a real size of the respective spectacle frame;

(b) providing a posting platform 20 which is linked to the frame database 11, wherein the user is able to post a facial image 21 thereof on the posting platform 20 through the public communication network, wherein two pupils of the user are shown on the facial image 21;

(c) selecting at least one of the spectacle frame images 12 from the frame database 11;

(d) calibrating the frame scale with respect to the two pupil marks 31 respectively located at two pupils on the facial image 21 wherein the two pupil marks 31 is arranged for proportionally representing a real distance between the two pupils of the user; and

(e) simulating a virtual appearance of the user test-wearing the respective spectacle frame when the spectacle frame image 12 selected by the user is fittingly overlapped on the facial image 21.

In order to measure the distance between the two pupil marks 31, step (d) further comprises the steps of:

(d.1) moving a longitudinal measuring line 321 on the posting platform 20 until the longitudinal measuring line 231 is longitudinally aligned with the two pupils of the user on the facial image 21;

(d.2) moving two transverse measuring lines 322 on the posting platform 20 until the transverse measuring lines 322 are transversely aligned with the two pupils of the user on the facial image respectively; and

(d.3) determining the two pupil marks 31 formed at two intersections of the longitudinal measuring line 321 and the transverse measuring lines 322.

Thus, step (d.2), further comprises a step of providing a measuring scale 323 longitudinally formed on the posting platform 20 to measure a distance between the two transverse measuring lines 322 for proportionally determining the real distance between the two pupils of the user.

Moreover, step (d) further comprises a step of:

(d.4) proportionally zooming in and out of the facial image 21 on the posting platform 20 until the two pupil marks 31 are proportionally located at the two pupils on the facial image 21 corresponding to the real distance between the two pupils of the user.

The spectacle frame image 12 is meant to produce an optimal simulation of the spectacle frame on the facial image 21, so that step (e) further comprises the step of aligning the two pupil marks 31 with two focus points of lenses simulated in the spectacle frame image 12 when the spectacle frame image 12 is overlapped on the facial image 21 for simulating the virtual appearance of the user test-wearing the respective spectacle frame.

In order to produce the reflection effect on the facial image, step (e) further comprises the step of generating a reflection effect on each of the lenses to modify the lenses of each of the spectacle frame images 12 when the spectacle frame image 12 is overlapped on the facial image 21 so as to enhance the virtual appearance of the user test-wearing the respective spectacle frame.

Likewise, the shading of facial image 21 requires that step (e) further comprises the step of generating a frame shading on the facial image 21 with respect to the spectacle frame image 12 to modify each of the spectacle frame images 12 when the spectacle frame image 12 is overlapped on the facial image 21 so as to enhance the virtual appearance of the user test-wearing the respective spectacle frame.

Moreover, step (e) further comprises the steps of providing two temples at two outer sides of the lenses respectively; forming a visible portion of each of the temples extended from the outer side of the respective lens to a facial side peripheral of the facial image 21; and forming an invisible portion of each of the temples extended from the visible portion thereof at a position out of the facial side peripheral of the facial image 21.

In order to store the digital image of the spectacle frames, step (a) further comprises the step of providing a user database linked to the posting platform 20 to store the virtual appearance as a digital image with information of the user and the respective spectacle frame image 12 selected by the user.

In light of the above-mentioned optical products optimization system, an alternative mode of the method of optimizing optical products is that step (d), further comprises the steps of:

(d.1) moving two pupil pointers 33′ on the posting platform 20 at the pupils on the facial image 21; and

(d.2) determining the two pupil marks 31 when the two pupil pointers 33′ are overlappedly located at the pupils on the facial image 21.

According to this alternative mode, all the steps are the same except step (d.1) and step (d.2). However, instead of using the two measuring lines 321, 322, this alternative mode of the present invention utilizes two pupil pointers 33′ to determine the distance between the two pupils.

According to the preferred embodiment, after the spectacle frame image 12 is matched with the facial image 21, the method further comprises the step of generating a temple effect for each of the temples of the spectacle frame image 12. The visible portion extended from the outer side of the respective lens to a facial side peripheral of the facial image 21 and the invisible portion is extended from the visible portion at a position out of the facial side peripheral of the facial image 21. Therefore, the virtual appearance is generated for the user to test-wear the spectacle frame in responsive to the spectacle frame image 12 thereof, such that the spectacle frame image 12 matches with a facial size of the facial image 21 of the user.

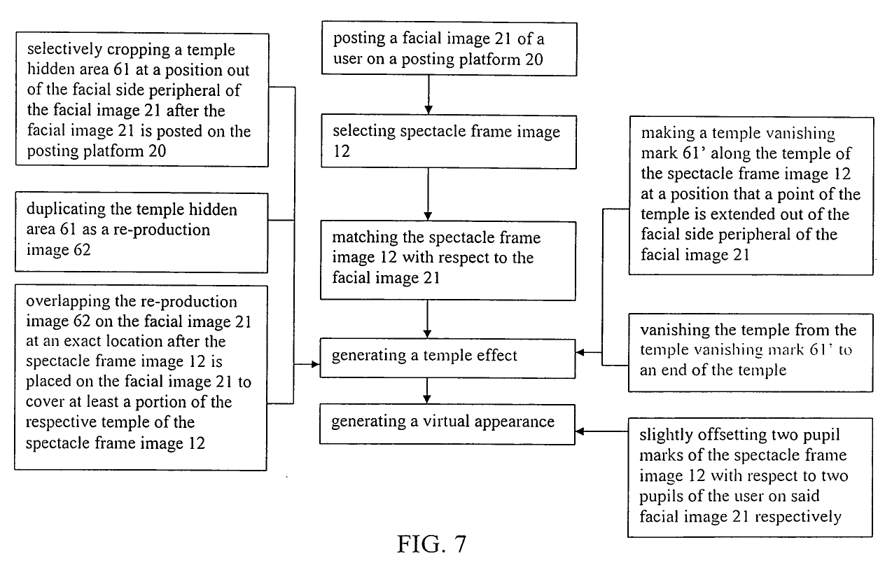

As shown in FIGS. 7 to 9, in order to generate the temple effect, the above mentioned step further comprises the following steps.

(A) Selectively crop at least a temple hidden area 61 at a position out of the facial side peripheral of the facial image 21 after the facial image 21 is posted on the posting platform 20.

(B) Duplicate the temple hidden area 61 as a re-production image 62.

(C) Overlap the re-production image 62 on the facial image 21 at an exact location after the spectacle frame image 12 is placed on the facial image 21 to cover at least a portion of the respective temple of the spectacle frame image 12, wherein the portion of the temple becomes the invisible portion thereof after the re-production image 62 covers thereon.

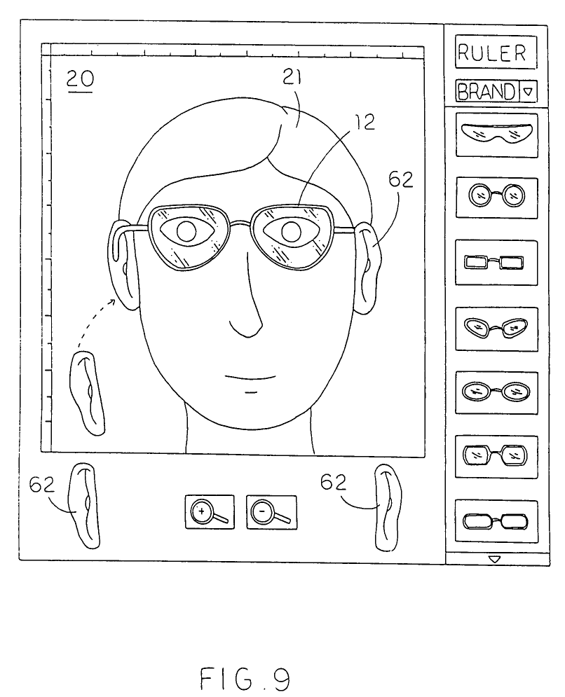

In the step (A), the user is able to move two area pointers, preferably, at the facial image 21 at two outer side of the facial side peripheral thereof. For example, the two area pointers are located at the auricles of the user's facial image 21 on the posting platform 20. Therefore, the user is able to crop each of the area pointers on the facial image 21 until the area pointer covers the entire auricle of the facial image 21 to form the temple hidden area 61, as shown in FIG. 9. Another example is that for a lady having a long hair covering the auricles thereof, the user is able to move the area pointers at the outer sides of the facial side peripheral to cover the hair around the auricles of the facial image 21. It is because when the user physically wears the spectacle frame, the end portions of the temples are hidden behind the auricles of the user respectively. In other words, the temple hidden area 61 is the area where the portion of the temple cannot be seen on the facial image 21 in responsive to the actual wearing appearance of the user. If the user accidentally crops the wrong temple hidden area, the user can always undo the pervious action and re-crop the temple hidden area 61 until the confirmation is made. Therefore, once the user confirms the temple hidden area 61 being cropped, the system of the present invention will then duplicate the temple hidden area 61 as the re-production image 62 in the step (B).

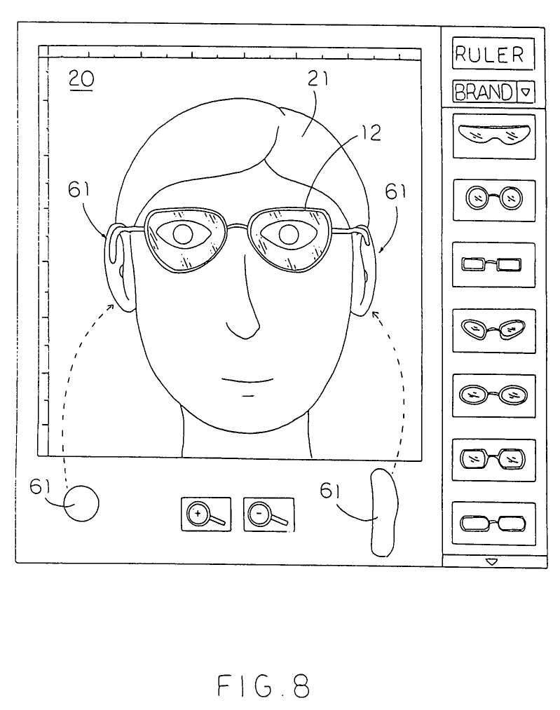

Accordingly, for cropping the temple hidden area 61, the method in the step (A) further comprises a step of adjusting a size and shape of the temple hidden area 61 until the temple hidden area covers from an end portion of the respective temple of the spectacle frame image 12 to the facial side peripheral of the facial image 21, as shown in FIG. 8. The user is able to selectively adjust the size and shape of the temple hidden area to entirely cover the auricle on the facial image 21. Likewise, the temple hidden area 61 can be automatically cropped in responsive to a shape and size of auricles on the facial image 21.

Once the temple hidden area 61 is cropped and duplicated in the step (B), the reproduction image is temporarily saved until the facial image 21 is removed from the posting platform 20. In other words, the reproduction image will be kept as long as the facial image 21 is still posted on the posting platform 20. Therefore, the re-production image 62 is remained to overlap on the facial image 21 when the spectacle frame image 12 is replaced by another the spectacle frame image 12 to be selected for matching with the facial image 21. The user is able to select another spectacle frame image 12 to replace the one on the posting platform 20 while the reproduction image will be remained on the posting platform 20 to form the invisible portion of the spectacle frame image 12.

In order to enhance the test-wearing image of the virtual appearance, the step (e) further comprises a step of slightly offsetting the two pupil marks 31 of the spectacle frame image 12 with respect to the two pupils of the user on the facial image 21 respectively. Accordingly, when the user physically wears the spectacle frame, the spectacle frame will be slightly moved due to the weight of the spectacle frame and the movement of the user' head. In other words, when the physically wears the spectacle frame, the two pupil marks 31 of the spectacle frame image 12 are slightly offset with respect to the two pupils of the user respectively.

The generating means further comprises a virtual appearance enhancer modifying the virtual appearance, wherein the virtual appearance enhancer automatically shifts a scale between the spectacle frame image 12 and the facial image 21 at a position that two pupil marks 31 of the spectacle frame image 12 are slightly offset with respect to two pupils of the user on the facial image 21 respectively.

According to the preferred embodiment, the pupil marks 31 of the spectacle frame image 12 are downwardly and outwardly moved to offset the pupils of the user on the facial image 21 respectively. In order to achieve the final enhancing effect, the system of the present invention will either re-scale the spectacle frame image 12 with respect to the facial image 21 or re-scale the facial image 21 with respect to the spectacle frame image 12. In other words, the system of the present invention will re-scale the spectacle frame image 12 to offset the two pupil marks 31 of the spectacle frame image 12 with respect to the two pupils of the facial image 21. Or, the system of the present invention will re-scale the facial image 21 to offset the two pupils of the facial image 21 with respect to the two pupil marks 31 of the spectacle frame image 12. Accordingly, the pupil marks 31 of the spectacle frame image 12 are downwardly moved 2 mm and outwardly moved 2 mm to offset the pupils of the user on the facial image 21 respectively by the actual scale between the spectacle frame image 12 and the facial image 21. In other words, if the facial image 21 is shrunk to reduce its size to be displayed on the posting platform 20, the pupil marks 31 of the spectacle frame image 12 are downwardly and outwardly moved lesser than 2 mm to offset the pupils of the user on the facial image 21 respectively in responsive to the actual size of the facial image 21. It is worth to mention that the above mentioned offsetting effect is only generated for test-wearing purpose.

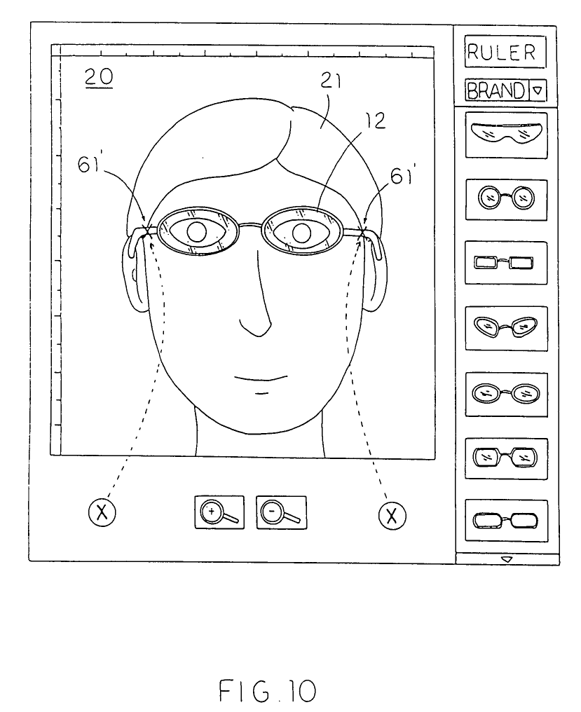

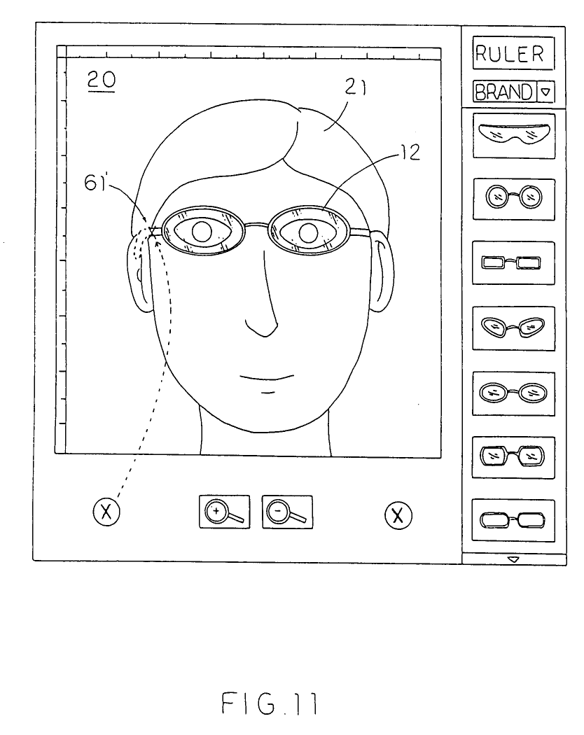

FIGS. 10 to 11 illustrate an alternative method to modify the temple effect module for generating the temple effect, wherein the step comprises the following steps.

(A′) Make a temple vanishing mark 61′ along the temple of the spectacle frame image 12 at a position that a point of the temple is extended out of the facial side peripheral of the facial image 21, as shown in FIG. 10.

(B′) Vanish the temple from the temple vanishing mark 61′ to an end of the temple such that the visible portion forms from the outer side of the respective lens to temple vanishing mark 61′ while the invisible portion forms from the temple vanishing mark 61′ to the end of the temple, as shown in FIG. 11.

As it is mentioned above the spectacle frame images 12 are saved in a digital form that each of the spectacle frame images 12 can be modified along the temple thereof. Accordingly, after the spectacle frame image 12 is overlapped on the facial image 21, the user is able to determine the invisible portion of the temple. In order to generate the temple effect, the temple vanishing mark 61′ is made by a click of a mouse. Therefore, by pointing the temple vanishing mark 61′ along the temple of the spectacle frame image 12, a click of the mouse will activate the temple effect module to vanish the invisible portion of the temple. If the user accidentally makes the wrong temple vanishing mark 61′, the user can always undo the pervious action and re-make the temple vanishing mark 61′ until the confirmation is made. Therefore, once the user confirms the temple vanishing mark 61′ being made, the system of the present invention will then form the invisible portion of the temple in the step (B′).

Accordingly, the user is able to use the system of the present invention for test wearing all the frames through Internet. The user can also pre-load the software containing the system of the present invention as into the personal computer. Likewise, the spectacle shop can pre-load the software containing the system of the present invention as into the personal computer or can simply provide a computer that can access Internet. Therefore, the user is able to go to the spectacle shop and sit in front of the computer to test wear all the frames. A salesman or an optician working at the spectacle shop can help the user to post the facial image 21 of the user on the posting platform 20 and to input the above mentioned information to allow the system of the present invention.

As mentioned as the objects of the present invention, it may be utilized in a business context in which the method of shopping optical products through a communication network comprises the steps of:

(1) providing a remote shopping center for a customer to access through the public communication network, wherein the remote shopping center provides a posting platform 20 allowing the customer to post a facial image 21 thereof through the public communication network;

(2) selecting at least one of spectacle frame images 12 from a frame database 11 to fittingly overlap the spectacle frame image 12 on the facial image 21, wherein each of the spectacle frame images 12 contains a frame scale with respect to a real size of the respective spectacle frame;

(3) simulating a virtual appearance of the customer test-wearing the respective spectacle frame; and

(4) receiving an order of the respective spectacle frame selected by the customer.

Step (3) further comprises a step of calibrating the frame scale with respect to two pupil marks 31 respectively located at two pupils on the facial image 21, wherein the two pupil marks 31 is arranged for proportionally representing a real distance between the two pupils of the customer.

Moreover, step (4) further comprises the steps of:

(4.1) receiving information of the spectacle frame from the customer;

(4.2) receiving confirmation of at least one of the spectacle frame selected by the customer; and

(4.3) sending orders for a manufacturer of the selected spectacle frame in accordance with the information and the confirmation of the corresponding spectacle frame image.

The information of the spectacle frame contains an authorized prescription for prescription lenses and color of lenses for sunglasses as the spectacle frame so that the manufacturer may fabricate the relevant spectacle frame with all the necessary information, i.e. the prescription and the design and the appearance of the spectacle frame.

As a result, the present invention may even be utilized to enhance integrity and promote customer's acceptance. Step (1) further comprises the steps of:

(1.1) enrolling the customer to be a member of the remote shopping center, wherein reference of the customer is stored in a user database; and

(1.2) assigning an authorization password for the customer to select the spectacle frame images from the frame database with respect to the reference of the customer.

It is worth mentioning that the remote shopping center is preferably embodied as a user terminal, such as a computer, of the pubic communication network so that the customer may just simply order his/her spectacle via his own computer within needing to physically visit a spectacle retail stores or an optometry.

Step (2) further comprises a step of sorting out the newest and the most popular spectacle frame images from the frame database 11 for the customer to select so as to promote the spectacle frames through the public communication network.

Moreover, Step (1) further comprises a step of providing a frame adjustment manual for the customer through the public communication network to adjust a nose piece and temples of the spectacle frame ordered by the customer for being fittingly worn by the customer.

The frame adjustment manual allows the customer to self-adjust his spectacle frame in a proper manner so that he/she does not need to physically visit an optometrist for lenses alignments or minor spectacle frame adjustment.

In order to promote interaction between the customer and the seller of the spectacle and advertising thereof, the method of shopping spectacle frames further comprises a step of market testing a new spectacle frame by posting surveys through the public communication network so as to allow the customer sending feedback of the survey. In such cases, customers' impression as to the service of the sellers of the spectacle frames can be enhanced so as to boost up the spectacle selling business.

The method of shopping optical products further comprises a step of delivering the spectacle frame with lenses which are manufactured in accordance with the confirmation and the authorized prescription. It is worth mentioning that the spectacle frame's delivery is preferably by mailing service so that the customer does not need to physically visit an optometry shop for ordering spectacle. Of course however, should be customer want to visit the optometry shop for testing the new spectacle, he/she will be most welcome.

Thus, the present invention provides an all-in-one platform for customers to select their desirable spectacle frames with their self-created facial image 21 and to provide prescription for the ordering of an optometrically manufactured spectacle using the public communication network, such as the Internet. As such, the customer may even order their favorite spectacle at home or indeed anywhere they like, provided that they have obtained the corresponding authorized prescription.

Accordingly, the present invention provides the calibration device 30 calibrates the frame scale with the two pupil marks 31 at the pupils of the user. Since most of the users do not know the real distance between the two pupils thereof, the present invention further provides a method for the user to test wear all the frames without physically wearing the spectacle frames.

In order to test wear all the frames, the user is able to input the general information as basic personal information, such as gender, age, and race, to generally make a searching inquiry. Accordingly, there are two different genders, i.e. male and female, to statistically classify the range of the pupil-distance so as refine the size of the frame. For the factor of age, the system of the present invention contains three categories for classifying the sizes of the frame, i.e. senior, junior, and adult, to further refine the size of the frame. It is worth to mention that each category can be further broken down into several sub-categories such as teenage, and preteen. For the factor of race, Asian has a statistical range of the pupil-distance which is different from the statistical range of the pupil-distance for European. Therefore, by inputting the race, the system of the present invention is adapted to generate a statistical range of the pupil-distance for the corresponding race. As a result, by combining the factors of gender, age, and race, the system can statistically determine the range of the pupil-distance for the user.

Furthermore, detail information can also be input to make an advance search, wherein the detail information contains the height and weight of the user, and the facial shape of the user. Accordingly, by inputting the gender, age, race, height and weight of the user, the corresponding size of the eyeglasses frame can be presumably filtered from the database. In particularly, having the facial shape of the user, such as round shape or oval shape, the distance between the two pupils of the user can be presumable calculated. It is worth to mention that the information of gender, age height, weight, and facial shape of the user can only used for test wearing purpose. To purchase the eyeglasses, the user must provide a precise distance between the pupils of the user for matching the focus of each of the lenses.

Accordingly, the height of the user is considered as one of the major factors to determine the distance between the pupils of the user because the increase of the pupil-distance is in proportion to the increase of the height of the user. Statistically speaking, the statistical data for the height has a range between 1 m to 2 m and the statistical data for the pupil-distance has a range between 40 mm to 200 mm with respect to the height. Therefore, by inputting the data of the height of the user, the system of the present invention is adapted to statistically determine the distance of the pupils of the user so as to minimize the error thereof.

It is worth to mention that all above mentioned information, including gender, age, race, height, weight, and the facial shape of the user, is basic information wherein all the users are able to provide such information. Having such information, the system of the present invention is adapted to statistically determine the distance of the pupils of the user. The error of the statistical distance by the system would be less than 3 mm difference of the real distance of the pupils of the user. Accordingly, the optimization center 10 further contains a statistical distance database storing the statistical data of the distance of the pupils of the user regarding to the information of gender, age, race, height, weight, and the facial shape of the user. Of course, if the user is able to provide more information, the error of the statistical distance by the system will be further minimized.

According to the preferred embodiment, the optimization center 10 further comprises an input device for the user to input the basic information of gender, age, race, height, weight, and the facial shape of the user to statistically determine the distance of the pupils of the user.

Accordingly, the user is able to use the system of the present invention for test wearing all the frames. The user can pre-load the software containing the system of the present invention as into the personal computer or can access the system of the present invention through Internet. By simply posting the facial image 21 of the user on the posting platform 20, the user is able to input the above mentioned information to allow the system of the present invention to statistically determine the distance of the pupils of the user. Since the error between the statistical distance by the system and the real distance of the pupils of the user is relatively small, the user is able to select the at least one of the spectacle frame images 12 from the frame database 11 as mentioned in the above method.

Likewise, the spectacle shop can pre-load the software containing the system of the present invention as into the personal computer or can simply provide a computer that can access Internet. Therefore, the user is able to go to the spectacle shop and sit in front of the computer to test wear all the frames. In other words, a salesman or an optician working at the spectacle shop can help the user to post the facial image 21 of the user on the posting platform 20 and to input the above mentioned information to allow the system of the present invention to statistically determine the distance of the pupils of the user. Therefore, the user will have hundreds of chances of trying some other spectacle designs before making decision.

From the forgoing descriptions, it can be shown that the above objects have been substantially accomplished. The present invention provides a system and method of optimizing and shopping optical products through a public communication network, wherein the customer is able to customize the optical products through the public communication network to selectively match the face image with the optical products without physically wearing on the optical products. Moreover, the present invention can be utilized as a business method in retailing of spectacle frames with authorized prescription.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of producing test-wearing face image for optical products, comprising the steps of:
(a) posting a facial image of a user on a posting platform;
(b) selecting at least one of spectacle frame images from a frame database, wherein each of said spectacle frame images contains images of two lens, two temples outwardly extended from two outer sides of said lens respectively, and a spectacle bridge extended between two inner sides of said lens respectively;
(c) matching said spectacle frame image with respect to said facial image;
(d) generating a temple effect for each of said temples of said spectacle frame image to form a visible portion extended from said outer side of said respective lens to a facial side peripheral of said facial image and an invisible portion extended from said visible portion at a position out of said facial side peripheral of said facial image; and
(e) generating a virtual appearance of said user test-wearing a spectacle frame in responsive to said spectacle frame image thereof, such that said spectacle frame image matches with a facial size of said facial image of said user.

2. The method, as recited in claim 1, wherein the step (d) comprises the steps of:
(d.1) selectively cropping at least a temple hidden area at a position out of said facial side peripheral of said facial image after said facial image is posted on said posting platform;
(d.2) duplicating said temple hidden area as a re-production image; and
(d.3) overlapping said re-production image on said facial image at an exact location after said spectacle frame image is placed on said facial image to cover at least a portion of said respective temple of said spectacle frame image, wherein said portion of said temple becomes said invisible portion thereof after said re-production image covers thereon.

3. The method, as recited in claim 2, wherein the step (d.1) further comprises a step of adjusting a size and shape of said temple hidden area until said temple hidden area covers from an end portion of said respective temple of said spectacle frame image to said facial side peripheral of said facial image.

4. The method as recited in claim 2 wherein, in the step (d.1), said temple hidden area is automatically cropped in responsive to a shape and size of auricles on said facial image.

5. The method, as recited in claim 3, wherein said reproduction image is temporarily saved until said facial image is removed from said posting platform, such that said re-production image is remained to overlap on said facial image when said spectacle frame image is replaced by another said spectacle frame image to be selected for matching with said facial image.

6. The method, as recited in claim 4, wherein said reproduction image is temporarily saved until said facial image is removed from said posting platform, such that said re-production image is remained to overlap on said facial image when said spectacle frame image is replaced by another said spectacle frame image to be selected for matching with said facial image.

7. The method, as recited in claim 5, wherein the step (c) further comprises a step of calibrating a frame scale of said spectacle frame image with respect to two reference marks respectively located at two reference images on said facial image wherein said two reference marks are arranged for proportionally representing a real distance between said two reference images of said user.

8. The method, as recited in claim 6, wherein the step (c) further comprises a step of calibrating a frame scale of said spectacle frame image with respect to two reference marks respectively located at two reference images on said facial image wherein said two reference marks are arranged for proportionally representing a real distance between said two reference images of said user.

9. The method, as recited in claim 7, wherein said two reference marks are two pupil marks of said spectacle frame image and said two reference images on said facial image are two pupils of said user on said facial image.

10. The method, as recited in claim 8, wherein said two reference marks are two pupil marks of said spectacle frame image and said two reference images on said facial image are two pupils of said user on said facial image.

11. The method, as recited in claim 1, wherein the step (e) further comprises a step of slightly offsetting two pupil marks of said spectacle frame image with respect to two pupils of said user on said facial image respectively, wherein said pupil marks of said spectacle frame image are downwardly and outwardly moved to offset said pupils of said user on said facial image respectively.

12. The method, as recited in claim 9, wherein the step (e) further comprises a step of slightly offsetting said two pupil marks of said spectacle frame image with respect to said two pupils of said user on said facial image respectively, wherein said pupil marks of said spectacle frame image are downwardly and outwardly moved to offset said pupils of said user on said facial image respectively.

13. The method, as recited in claim 10, wherein the step (e) further comprises a step of slightly offsetting said two pupil marks of said spectacle frame image with respect to said two pupils of said user on said facial image respectively, said pupil marks of said spectacle frame image are downwardly and outwardly moved to offset said pupils of said user on said facial image respectively.

14. The method, as recited in claim 1, wherein the step (d) further comprises the steps of:
(d.1) making a temple vanishing mark along said temple of said spectacle frame image at a position that a point of said temple is extended out of said facial side peripheral of said facial image; and
(d.2) vanishing said temple from said temple vanishing mark to an end of said temple such that said visible portion forms from said outer side of said respective lens to temple vanishing mark while said invisible portion forms from said temple vanishing mark to said end of said temple.

15. The method, as recited in claim 6, wherein said temple vanishing mark is made by a click of a mouse.

16. The method, as recited in claim 15, wherein the step (c) further comprises a step of calibrating a frame scale of said spectacle frame image with respect to two reference marks respectively located at two reference images on said facial image wherein said two reference marks are arranged for proportionally representing a real distance between said two reference images of said user.

17. The method, as recited in claim 16, wherein said two reference marks are two pupil marks of said spectacle frame image and said two reference images on said facial image are two pupils of said user on said facial image.

18. The method, as recited in claim 17, wherein the step (e) further comprises a step of slightly offsetting said two pupil marks of said spectacle frame image with respect to said two pupils of said user on said facial image respectively, wherein said pupil marks of said spectacle frame image are downwardly and outwardly moved to offset said pupils of said user on said facial image respectively.

19. A system of producing test-wearing face image for optical products, comprising:
an optimization center having a frame database, which is adapted for a user to access, containing a plurality of digital spectacle frame images of a plurality of spectacle frames for said user to select, wherein each of said spectacle frame images contains a frame scale with respect to a real size of said respective spectacle frame, wherein each of said spectacle frame images further contains images of two lens, two temples outwardly extended from two outer sides of said lens respectively, and a spectacle bridge extended between two inner sides of said lens respectively;
a posting platform, which is communicatively linked to said frame database, for said user posting a facial image thereof on said posting platform; and
a calibration device calibrating said frame scale with two reference marks respectively located at two reference images on said facial image, wherein said two reference marks are arranged for proportionally representing a real distance between said two reference images of said user;
a temple effect module modifying said temple of each of said spectacle frame images when said spectacle frame image is overlapped on said facial image for enhancing said virtual appearance of said user test-wearing said respective spectacle frame, wherein said temple effect module modifies each of said temples to form a visible portion extended from said outer side of said respective lens to a facial side peripheral of said facial image and an invisible portion extended from said visible portion at a position out of said facial side peripheral of said facial image; and
means for generating simulating a virtual appearance of said user test-wearing said respective spectacle frame on said posting platform, such that said spectacle frame image matches with a facial size of said facial image of said user.

20. The system, as recited in claim 19, wherein said temple effect module generates and duplicates at least a temple hidden area at a position out of said facial side peripheral of said facial image after said facial image is posted on said posting platform, such that said re-production image is overlapped on said facial image at an exact location after said spectacle frame image is placed on said facial image to cover at least a portion of said respective temple of said spectacle frame image to form said invisible portion thereof.

21. The system, as recited in claim 19, wherein said temple effect module provides a temple vanishing mark along said temple of said spectacle frame image at a position that a point of said temple is extended out of said facial side peripheral of said facial image, wherein said temple is vanished from said temple vanishing mark to an end of said temple such that said visible portion forms from said outer side of said respective lens to temple vanishing mark while said invisible portion forms from said temple vanishing mark to said end of said temple.

22. The system, as recited in claim 20, wherein said generating means further comprises a virtual appearance enhancer modifying said virtual appearance, wherein said virtual appearance enhancer automatically shifts a scale between said spectacle frame image and said facial image at a position that two pupil marks of said spectacle frame image are slightly offset with respect to two pupils of said user on said facial image respectively.

23. The system, as recited in claim 21, wherein said generating means further comprises a virtual appearance enhancer modifying said virtual appearance, wherein said virtual appearance enhancer automatically shifts a scale between said spectacle frame image and said facial image at a position that two pupil marks of said spectacle frame image are slightly offset with respect to two pupils of said user on said facial image respectively.
